(19) United States
(12) Patent Application Publication
(10) Pub. No.: US 2026/0360102 A1
(43) Pub. Date: Nov. 12, 2026

(54) ENHANCED DECISION MAKING THROUGH FEW-SHOT ADAPTATION OF ARTIFICIAL INTELLIGENCE MODELS FOR ACTION DETECTION

(71) Applicant: NEC Laboratories America, Inc., Princeton, NJ (US)

(72) Inventors: Deep Patel, Mount Holly, NJ (US); Iain Melvin, Princeton, NJ (US); Zachary Izzo, Cranbury, NJ (US)

(21) Appl. No.: 19/662,703

(22) Filed: Apr. 29, 2026

Related U.S. Application Data
(60) Provisional application No. 63/802,678, filed on May 9, 2025.

(51) Int. Cl. G06V 10/25; B60W 30/09; G06N 20/00; G06V 10/74; G06V 10/77

(52) U.S. Cl. CPC G06V 10/25; B60W 30/09; G06N 20/00; G06V 10/761; G06V 10/7715

(57) ABSTRACT

Systems and methods for enhanced decision making through few-shot adaptation of artificial intelligence models for action detection. Augmented feature maps can be obtained by injecting feature augmentations of detected features from video frames into a feature space of a vision encoder of a machine learning model. The vision encoder can be trained to learn low rank adaptation parameters based on the augmented feature maps. Entity level features can be extracted from the video frames by performing region of interest alignment on the augmented feature maps obtained by the vision encoder injected with low rank adaptation (LoRA) parameters. Similarity between the entity level features and action text embeddings obtained from the video frames can be maximized by minimizing an alignment loss to train the machine learning model and obtain an optimized machine learning model for performing downstream tasks.

### RELATED APPLICATION INFORMATION

This application claims priority to U.S. Provisional App. No. 63/802,678, filed on May 9, 2025, incorporated herein by reference in its entirety.

### BACKGROUND

### Technical Field

The present invention relates to optimizing training of artificial intelligence (AI) models, and more particularly to enhanced decision making through few-shot adaptation of artificial intelligence models for action detection.

### Description of the Related Art

Large-scale pre-trained models, particularly Video-Language Models (VLMs), have demonstrated remarkable capabilities in understanding multimodal data, achieving state-of-the art results on various video and language tasks. These models can be leveraged for downstream applications like text-to-image generation as they deliver strong performance even without task-specific training with massive datasets.

### SUMMARY

According to an aspect of the present invention, a method is provided, including, obtaining augmented feature maps by injecting feature augmentations of detected features from video frames into a feature space of a vision encoder of a machine learning model, training the vision encoder to learn low rank adaptation parameters based on the augmented feature maps, extracting entity level features from the video frames by performing region of interest alignment on the augmented feature maps obtained by the vision encoder injected with low rank adaptation (LoRA) parameters, and maximizing similarity between the entity level features and action text embeddings obtained from the video frames by minimizing an alignment loss to train the machine learning model and obtain an optimized machine learning model for performing downstream tasks.

According to another aspect of the present invention, a system is provided, including, a memory device, one or more processor devices operatively coupled with the memory device to perform operations including, obtaining augmented feature maps by injecting feature augmentations of detected features from video frames into a feature space of a vision encoder of a machine learning model, training the vision encoder to learn low rank adaptation parameters based on the augmented feature maps, extracting entity level features from the video frames by performing region of interest alignment on the augmented feature maps obtained by the vision encoder injected with low rank adaptation (LoRA) parameters, and maximizing similarity between the entity level features and action text embeddings obtained from the video frames by minimizing an alignment loss to train the machine learning model and obtain an optimized machine learning model for performing downstream tasks.

According to yet another aspect of the present invention, a non-transitory computer program product including a computer-readable storage medium including a program code, wherein the program code when executed on a computer causes the computer to perform operations including, obtaining augmented feature maps by injecting feature augmentations of detected features from video frames into a feature space of a vision encoder of a machine learning model, training the vision encoder to learn low rank adaptation parameters based on the augmented feature maps, extracting entity level features from the video frames by performing region of interest alignment on the augmented feature maps obtained by the vision encoder injected with low rank adaptation (LoRA) parameters, and maximizing similarity between the entity level features and action text embeddings obtained from the video frames by minimizing an alignment loss to train the machine learning model and obtain an optimized machine learning model for performing downstream tasks.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a system for enhanced decision making through few-shot adaptation of artificial intelligence models for action detection, in accordance with an embodiment of the present invention;

FIG. 2 is a block diagram that shows a computer system for enhanced decision making through few-shot adaptation of artificial intelligence models for action detection is illustratively depicted in accordance with an embodiment of the present invention;

FIG. 3 is a block diagram that shows components of a computer system for enhanced decision making through few-shot adaptation of artificial intelligence models for action detection, in accordance with an embodiment of the present invention;

FIG. 4 is a block diagram that shows components of a computer system for learning low rank adapter parameters for enhanced decision making through few-shot adaptation of artificial intelligence models for action detection, in accordance with an embodiment of the present invention;

FIG. 5 is a block diagram that shows components of the vision encoder to generate a feature map for enhanced decision making through few-shot adaptation of artificial intelligence models for action detection, in accordance with an embodiment of the present invention;

FIG. 6 is a flow diagram that shows a high-level overview of enhanced decision making through few-shot adaptation of artificial intelligence models for action detection, in accordance with an embodiment of the present invention; and

FIG. 7 is a block diagram that shows a practical application for enhanced decision making through few-shot adaptation of artificial intelligence models for action detection, in accordance with an embodiment of the present invention.

### DETAILED DESCRIPTION OF PREFERRED EMBODIMENTS

In accordance with embodiments of the present invention, systems and methods are provided for enhanced decision making through few-shot adaptation of artificial intelligence models for action detection.

In the present embodiments, augmented feature maps can be obtained by injecting feature augmentations of detected features from video frames into a feature space of a vision encoder of a machine learning model. The vision encoder can be trained to learn low rank adaptation parameters based on the augmented feature maps. Entity level features can be extracted from the video frames by performing region of interest alignment on the augmented feature maps obtained by the vision encoder injected with low rank adaptation (LoRA) parameters. Similarity between the entity level features and action text embeddings obtained from the video frames can be maximized by minimizing an alignment loss to train the machine learning model and obtain an optimized machine learning model for performing downstream tasks.

Large-scale pre-trained models, particularly Video-Language Models (VLMs), can be trained on millions of video and text pairs, focusing on entire scenes rather than specific person-centered actions. This large-scale training helps them capture strong spatial and temporal features, which can be adapted for detecting person-centered actions using only a small amount of additional training data.

However, a key drawback of VLMs is their size and computational demands, making them inefficient for real-time, cost-effective applications. VLMs processes patches from all the frames in the entire video frame at every layer resulting in computation requirement to increase with the number of layers and number of patches. Adapting these large models effectively, especially when labeled data for the target task is scarce, presents significant hurdles.

Fine-tuning the entire VLM, with its billions of parameters, on a small dataset inevitably leads to severe overfitting, hindering generalization.

Additionally, many powerful VLMs are pre-trained on tasks like video captioning or text-video retrieval, which typically involve reasoning about the global scene content. In contrast, action detection demands fine-grained understanding, requiring the localization of specific individuals and the identification of their potentially concurrent actions within complex scenes involving multiple people. This represents a significant granularity mismatch between pre-training objectives and the downstream task.

Moreover, while data augmentation is a standard technique to combat limited data, conventional augmentations applied at the input level (e.g., video transformations) may not be sufficient or optimally targeted for adapting the internal representations of a large frozen model. Generating diverse and task-relevant variations within the feature space could provide a more effective signal for adaptation, particularly for bridging the gap between scene-level pre-training and person-centric action detection.

Further, spatial temporal action detection requires fine grained labels for the location of the person with their actions. This kind of annotation is both time-consuming and costly.

The present embodiments resolve these issues by optimizing the training of machine learning models such as visual language models for learning action detection from just a few examples. Low-Rank Adaptation (LoRA) can be employed for parameter-efficient fine-tuning while keeping the machine learning models frozen to update low-rank matrices injected into specific layers of the machine learning model. To enhance data diversity and guide adaptation effectively, a learnable feature augmentation module can be applied internally within the frozen machine learning model. As such, the present embodiments improve accuracy of machine learning models to learn actions while increasing data efficiency by reducing the computational resources (e.g., compute and storage) needed to train the machine learning models.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

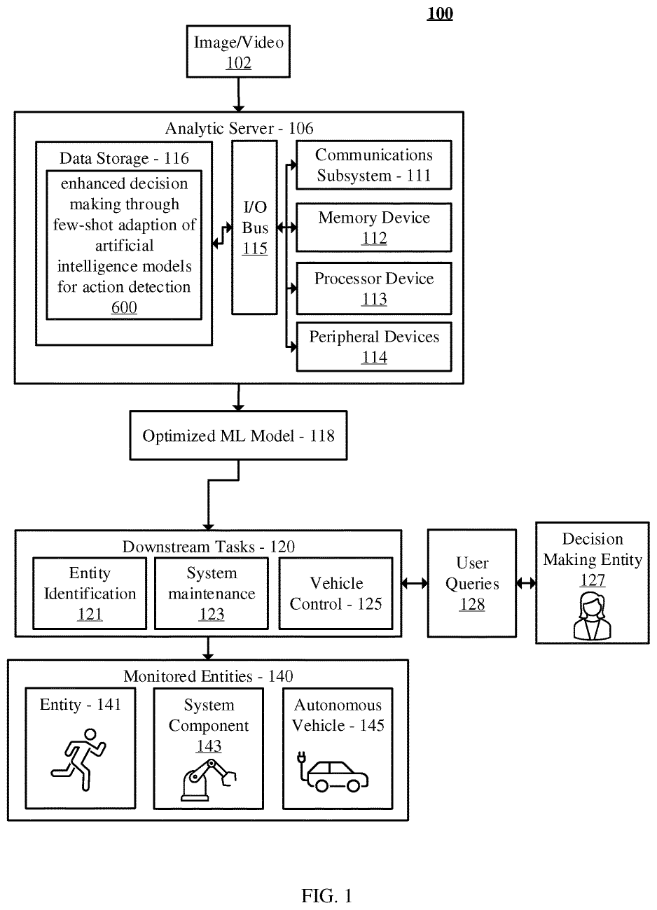

Referring now in detail to the figures in which like numerals represent the same or similar elements and initially to FIG. 1, a block diagram shows a system for enhanced decision making through few-shot adaptation of artificial intelligence models for action detection, in accordance with an embodiment of the present invention.

In an embodiment using a system 100, monitored entities 140 can include entity 141, system component 143, and autonomous vehicle 145. The monitored entities 140 can generate an input dataset that include image/video 102. The image/video 102 can be transmitted to an analytic server 106 that can implement enhanced decision making through few-shot adaptation of artificial intelligence models for action detection 600. The analytic server 106 can obtain an optimized machine learning (ML) model 118 The optimized ML model 118 can be utilized to perform downstream tasks 120.

System 100 can be utilized to perform downstream tasks 120 based on the input image/video 102 and user queries 128 from a decision-making entity 127. The downstream tasks 120 can include entity identification 121, system maintenance 123, and vehicle control 125. The analytic server 106 can generate a corrective action for the downstream tasks 120 to be sent to respective computing systems for the monitored entities 140 through a network.

In entity identification 121, the image/video 102 (e.g., location images, scene images, entity images such as parts of the entity, etc.) related to the entity 141 can be processed by the analysis server 106 to answer user queries 128. The user queries 128 can be relevant to the entity 141 such as their attributes (e.g., position, direction of movement, color of clothing, etc.), relationship with other entities within a scene (e.g., proximity, behavior, etc.), relationship with the environment, etc. The optimized ML model 118 can predict future attributes, and relationships of the entity 141.

Based on the predictions of the optimized ML model 118, a corrective action can be generated. The corrective action can include notifying the decision making entity 127 of the predictions about the entity 141 based on their image/video 102, generating resolutions to an issue caused by the entity (e.g., the entity 141 as a disabled vehicle in a traffic scene and the resolution is the deployment of a repair technician, etc.) of the image/video 102 to help with the decision making process of the decision making entity 127, etc. For example, an entity 141 (e.g., a worker, autonomous worker, etc.) in a warehouse performs task A in workflow D in manufacturing widget X. Outputs of entity 141 for task A is above the expected yield in the scheduled work period. Actions performed by entity 141 can then be learned and replicated to other entities 141 to increase yield in task A in workflow D. In another example, output of a first entity 141 has been below the expected yield and actions performed by a second entity 141 has been above the expected yield. As such, the layout of the warehouse can be updated to redirect the work to the second entity 141, and have first entity 141 flagged for maintenance.

In system maintenance 123, image/video 102 (e.g., system logs, test cases, hardware status images, etc.) related to the system component 143 can be processed to answer user queries 128. The user queries 128 can be relevant on how to properly maintain the system component 143 based on the image/video 102, the detected entities, and their corresponding detected actions. A corrective action can be generated by the analytic server 106 which can include the answer to the user queries 128 (e.g., determine causes to bandwidth issues, etc.) to maintain the system component 143. Based on the corrective action (e.g., adding bandwidth, blocking packets from an identified internet protocol (IP) address to resolve malicious attacks, restarting hardware, etc.) the network system can be autonomously maintained.

In vehicle control 125, image/video 102 (e.g., vehicle part status, traffic scene image, etc.) related to the autonomous vehicle 145 can be processed to answer user queries 128. The user queries 128 can be relevant to how to control the autonomous vehicle 145 given its environment based on the image/video 102, the detected entities, and their corresponding detected actions. A corrective action can be generated by the analytic server 106 which can include the answer to the user queries 128 to control the proper performance of the autonomous vehicle 145. Based on the corrective action (e.g., stopping, speeding up, changing direction, etc.) the autonomous vehicle 145 can be autonomously controlled using appropriate control devices (e.g., advanced driver assistance systems, braking device, accelerator device, cooling device, etc.) within the autonomous vehicle. In an embodiment, the autonomous vehicle 145 can be controlled in response to avoid a predicted event based on a generated trajectory such as multi-vehicle collision, accidents, detected road hazards, etc.

In another embodiment, in vehicle control 125, the autonomous vehicle 145 can be controlled to verify and test the functionality of the various components (e.g., advanced driver assistance systems, braking device, accelerator device, cooling device, etc.) of the autonomous vehicle 145 by autonomously controlling the components and generate test data that can be used to fine-tune/train the optimized ML model 118.

Other downstream tasks and practical applications are contemplated.

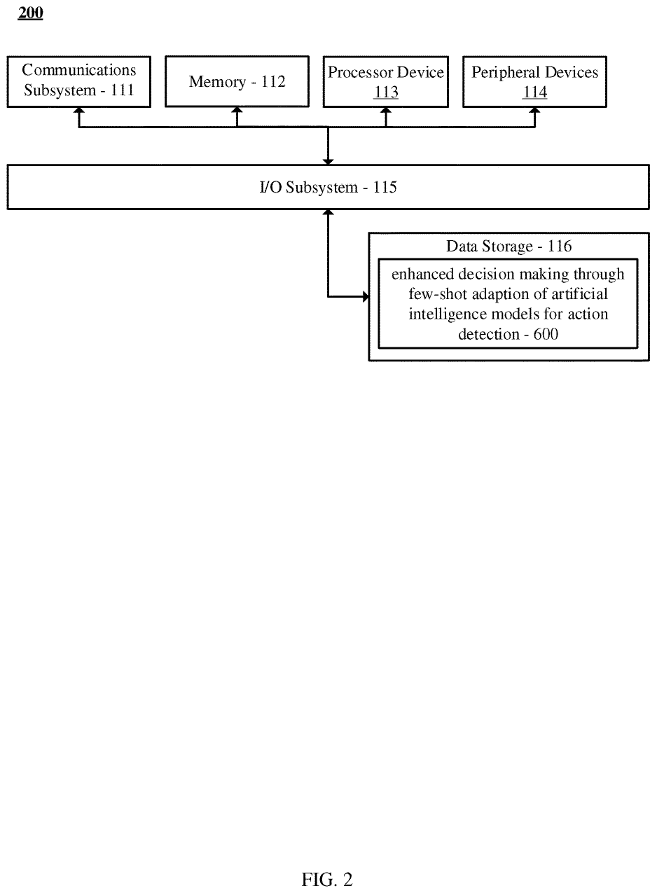

The analytic server 106 can include a processor device 113, data storage device 116, memory 112, communications subsystem 111, peripheral devices 114, and input/output (I/O) bus 115. The analytic server 106 is an implementation of a computer system. Other implementations are contemplated. The computer system is shown in more detail in FIG. 2.

Referring now to FIG. 2, a block diagram shows a computer system for enhanced decision making through few-shot adaptation of artificial intelligence models for action detection is illustratively depicted in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor device 113 in some embodiments.

The processor device 113 may be embodied as any type of processor capable of performing the functions described herein. The processor device 113 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 may be embodied as any type of volatile or non-volatile memory or data storage capable of performing the functions described herein. In operation, the memory 112 may store various data and software employed during operation of the computing device 200, such as operating systems, applications, programs, libraries, and drivers. The memory 112 is communicatively coupled to the processor device 113 via the I/O subsystem 115, which may be embodied as circuitry and/or components to facilitate input/output operations with the processor device 113, the memory 112, and other components of the computing device 200. For example, the I/O subsystem 115 may be embodied as, or otherwise include, memory controller hubs, input/output control hubs, platform controller hubs, extracted control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 113, the memory 112, and other components of the computing device 200, on a single extracted circuit chip.

The data storage device 116 may be embodied as any type of device or devices configured for short-term or long-term storage of data such as, for example, memory devices and circuits, memory cards, hard disk drives, solid state drives, or other data storage devices. The data storage device 116 can store program code for enhanced decision making through few-shot adaptation of artificial intelligence models for action detection 600. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 114. The peripheral devices 114 may include any number of additional input/output devices, interface devices, and/or other peripheral devices. For example, in some embodiments, the peripheral devices 114 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

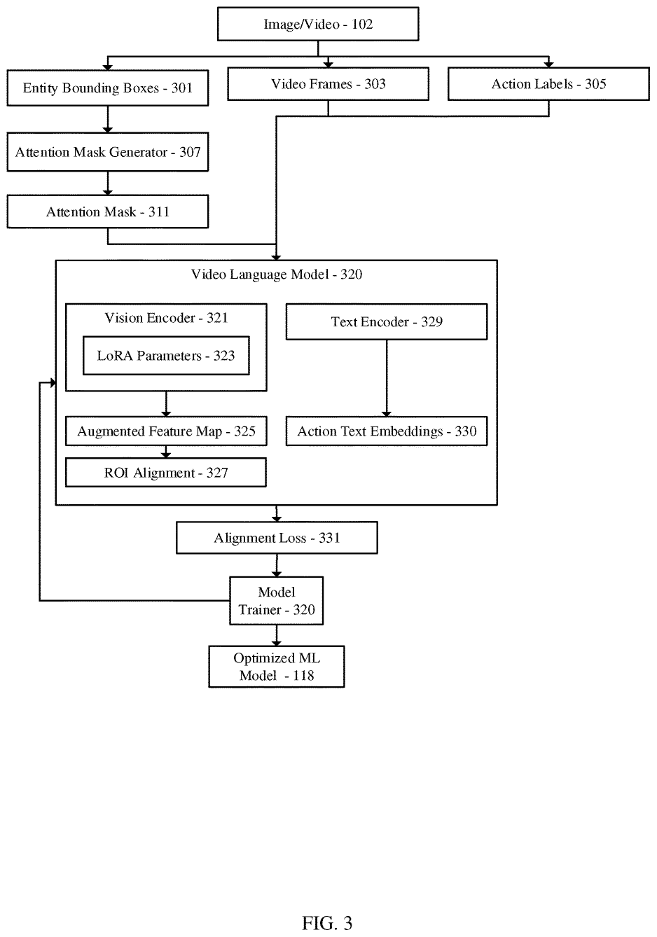

Referring now to FIG. 3, a block diagram shows components of a computer system for enhanced decision making through few-shot adaptation of artificial intelligence models for action detection, in accordance with an embodiment of the present invention.

In an embodiment, image/video 102 can be processed to train a video language model 320 and obtain an optimized ML model 118. The image/video 102 can be processed to extract entity bounding boxes 301, video frames 303 and action labels 305. An attention mask generator 307 can process the entity bounding boxes 301 to generate attention mask 311 for detected entities within the entity bounding boxes 301. The attention mask 311, video frames 303 and action labels 305 can be utilized by the video language model 320 for training.

The video language model 320 can include a vision encoder 321 and a text encoder 329. The vision encoder 321 can utilize low rank adaptation (LoRA) parameters 323 to generate augmented feature map 325 based on the video frames 303 and attention mask 311. The augmented feature map 325 can be processed to obtain region of interest alignment 327 which is an estimate of regions of interest that provides context for an entity performing an action. The text encoder 329 can process action labels 305 to generate action text embeddings 330.

The action text embeddings 330 and the ROI alignment 327 can be integrated into an alignment loss 331 for training the video language model 320 and obtain the optimized ML model 118.

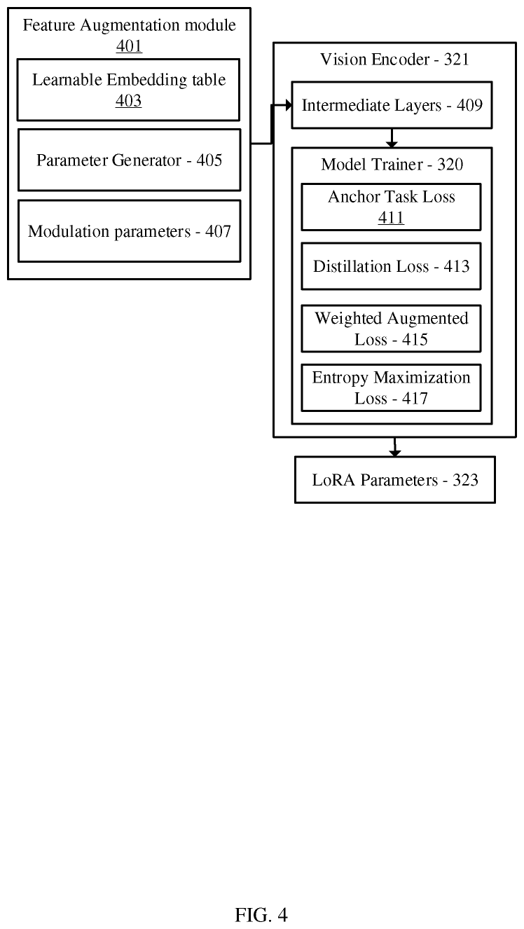

Referring now to FIG. 4, a block diagram shows components of a computer system for learning low rank adapter parameters for enhanced decision making through few-shot adaptation of artificial intelligence models for action detection, in accordance with an embodiment of the present invention.

In an embodiment, a feature augmentation model 401 can generate augmentations for video features for the vision encoder 321. The feature augmentation module 401 can be injected into the intermediate layers 409 of the vision encoder 321. The feature augmentation module 401 can include a learnable embedding table 403 and parameter generator 405 for performing feature-wise linear modulation (FILM) and learn modulation parameters 407. The augmented features generated with the feature augmentation module 401 can be utilized by the model trainer 320 to minimize a training objective including an anchor task loss 411, a distillation loss 413, a weighted augmented loss 415 and an entropy maximization loss 417 to learn the LoRA parameters 323.

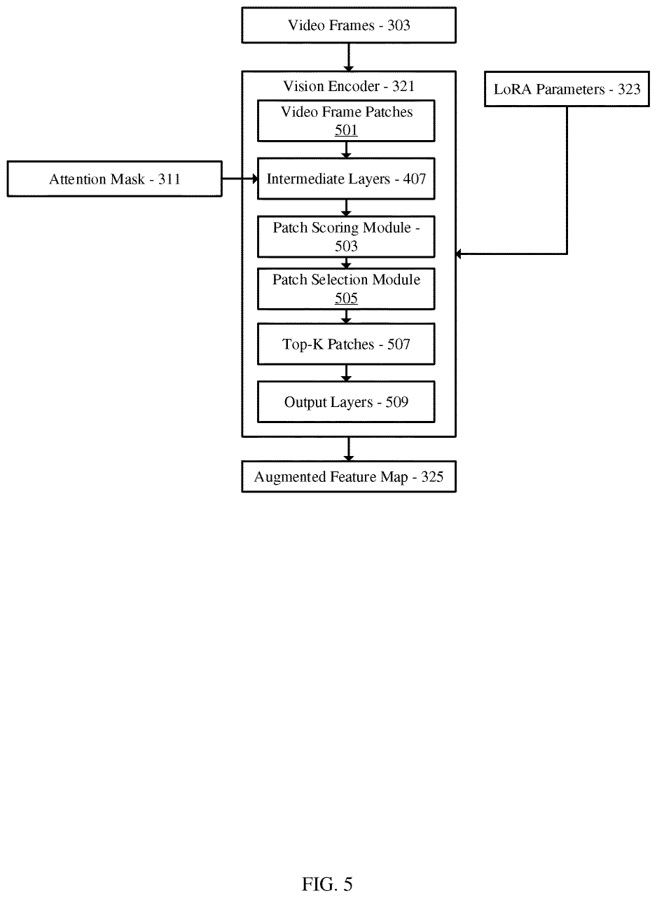

Referring now to FIG. 5, a block diagram shows components of the vision encoder to generate the feature map for enhanced decision making through few-shot adaptation of artificial intelligence models for action detection, in accordance with an embodiment of the present invention.

In an embodiment, video frames 303 can be processed by the vision encoder 321 to generate the augmented feature map 325. The vision encoder 321 can utilize the learned LoRA parameters 323 to generate the augmented feature map 325. The vision encoder 321 can extract video frame patches 501 from the video frames 303. The video frame patches 501 can be processed by the intermediate layers 409 of the vision encoder 321. An attention mask 311 can be injected into the intermediate layers 409 and generate feature vectors. The feature vectors can be processed by a patch scoring module 503 and the top-k patches 507 can be selected by the patch selection module 505. The top-K patches 507 can be processed by the output layers 509 of the vision encoder 321 to generate the feature map 325.

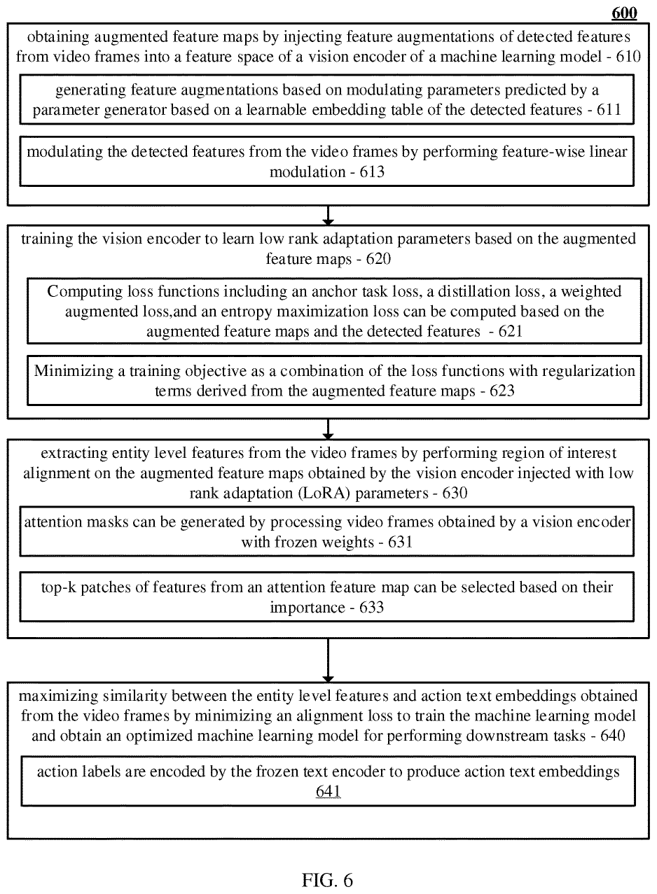

Referring now to FIG. 6, a flow diagram shows a high-level overview of enhanced decision making through few-shot adaptation of artificial intelligence models for action detection, in accordance with an embodiment of the present invention.

In an embodiment, augmented feature maps can be obtained by injecting feature augmentations of detected features from video frames into a feature space of a vision encoder of a machine learning model. The vision encoder can be trained to learn low rank adaptation parameters based on the augmented feature maps. Entity level features can be extracted from the video frames by performing region of interest alignment on the augmented feature maps obtained by the vision encoder injected with low rank adaptation (LoRA) parameters. Similarity between the entity level features and action text embeddings obtained from the video frames can be maximized by minimizing an alignment loss to train the machine learning model and obtain an optimized machine learning model for performing downstream tasks.

In the present embodiments, Low-Rank Adaptation (LoRA) can be employed to mitigate overfitting and reduce computational cost in the few-shot setting for detecting actions with machine learning models. LoRA injects trainable low-rank matrices into specific layers. For a pre-trained weight matrix W₀∈ [symbol] ^{d×k}, the adapted weight W is parameterized as W=W₀+BA, where B∈ [symbol] ^{d×r} and A∈ [symbol] ^{r×k} are trainable low-rank matrices with rank r<<min(d, k), while W₀ remains frozen.

LoRA can be applied to the query (W_{q}) and value (Wᵥ) projection matrices within the multihead self-attention (MHSA) modules of the vision encoder's transformer blocks, specifically from layer index lₗₒᵣₐ onwards. This focuses adaptation on higher-level visual features. Let θ denote the frozen pre-trained parameters of the VLM 320 and φₗₒᵣₐ represent the set of all trainable LoRA parameters 323 (the matrices A and B across the adapted layers). The optimized ML model 118 computes outputs based on both θ and φₗₒᵣₐ.

In block 610, injecting feature augmentations of detected features from video frames into the feature space of a vision encoder.

In an embodiment, to enhance generalization from limited data, augmentations can be introduced directly in the feature space of the vision encoder 321. A feature augmentation module 401 based on Feature-wise Linear Modulation (FILM) can be inserted after an intermediate layers 409 l_{aug} of the frozen vision encoder 321 backbone. Let f^{(l}^{_{aug}}⁾∈ [symbol] ^{B×T′×C} be the output feature map of layer l_{aug} for a batch of B input sequences, where T′ is the sequence length of visual tokens and C is the feature dimension.

In block 611, feature augmentations can be generated based on the modulating parameters predicted by a parameter generator based on a learnable embedding table.

In an embodiment, the feature augmentation module 401 generates N distinct augmented versions of these features. The feature augmentation module 401 can include: a learnable embedding table 403 E∈ [symbol] ^{N×D}^{ₑ}, where N is the number of augmentation types and De is the embedding dimension. Each row e; represents the i-th augmentation embedding.

To generate the augmentations, a parameter generator 405 g_{ψ}: [symbol] ^{D}^{ₑ}→ [symbol] ^{2C}, can be utilized and implemented as a small trainable MultiLayer Perceptron (MLP) with parameters Ψ. For each embedding et, it predicts modulation parameters 407 (γᵢ, βᵢ): (γᵢ, βᵢ)=g_{ψ}(eᵢ), γᵢ, βᵢ∈ [symbol] ^{C}(1) The parameters ψ and the embedding table E constitute the modulation parameters 407 φ_{aug} of this module. The parameter generator 405 g_{ψ} is initialized such that γᵢ≈1 and βᵢ≈0 initially for all i=1, . . . , N.

In block 613, detected features from the video frames can be modulated to generate augmented feature maps.

In an embodiment, the parameter generator 405 can perform a FILM application step where each (γᵢ, βᵢ) modulates the original features f^{(l}^{_{aug}}⁾ to produce the i-th augmented feature map

$${f}_{aug , i}^{( {l}_{aug} )} : {f}_{aug , i}^{( {l}_{aug} )} = {γ}_{i} ⊙ {f}^{( {l}_{aug} )} + {β}_{i} \qquad ( 2 )$$

where ⊙ denotes element-wise multiplication with broadcasting over the batch and sequence dimensions.

In block 620, the vision encoder can be trained to learn the low rank adaptation parameters and the modulation parameters based on the augmented feature maps and the detected features from the video frames.

In an embodiment, during training, the original features f^{(l}^{_{aug}}⁾ and all N augmented feature maps 325

$${\{ {f}_{aug , i}^{( {l}_{aug} )} \}}_{i = 1}^{N}$$

are passed through the subsequent layers of the network (which include the trainable LoRA parameters 323 φₗₒᵣₐ). This yields output logits z_{orig}∈ [symbol] ^{B×K} corresponding to the original features and a set of augmented logits

$${\{ {z}_{aug , i} ∈ {ℝ}^{B \times K} \}}_{i = 1}^{N} ,$$

where K is the number of output classes. The overall trainable parameters during optimization are φ=φₗₒᵣₐ∪φ_{aug} (e.g., modulation parameters 407 with the LoRA parameters 323).

In block 621, loss functions including an anchor task loss, a distillation loss, a weighted augmented loss, and an entropy maximization loss can be computed based on the augmented feature maps and the detected features.

In an embodiment, the Anchor Task Loss 411 ( [symbol] _{BCE}) can be defined as the standard supervised loss applied to the predictions from the original, unaugmented features z_{orig}. For multi-label classification, the Binary Cross-Entropy (BCE) loss with logits can be used:

$${ℒ}_{BCE} = \frac{1}{BK} B {\sum }_{b = 1}^{B} {\sum }_{k = 1}^{K} BCEWithLogits ( {z}_{orig , b , k} , {y}_{b , k} ) \qquad ( 4 )$$

where z_{orig,b,k} is the logit for the k-th class of the b-th sample.

In an embodiment, the Distillation Loss 413 ( [symbol] _{distill}) can be defined as a regularization term encouraging predictions from augmented features (z_{aug,i,}) to remain consistent with those from the original features (z_{orig}). The sigmoid probabilities derived from z_{orig} can be used as soft targets, detaching them from the gradient computation. Let p_{orig,b}=σ(z_{orig,b})_{detached}. The loss is the average BCE between augmented logits and these soft targets:

$${ℒ}_{distill} = \frac{1}{NBK} {\sum }_{i = 1}^{N} {\sum }_{b = 1}^{B} {\sum }_{k = 1}^{K} BCEWithLogits ( {z}_{aug , i , b , k} , {p}_{orig , b , k} ) \qquad ( 5 )$$

where σ(⋅) denotes the element-wise sigmoid function.

In an embodiment, the Weighted Augmented Loss 415 ( [symbol] _{BCE-W}) can be defined as the supervised BCE loss applied to predictions from augmented features, modulated by a per-sample weight w_{i,b}∈[0,1] reflecting the “reasonableness” of the i-th augmentation for the b-th sample. Let [symbol] _{ib} be the average BCE loss for the augmented sample (i,b):

$${ℓ}_{i , b} = \frac{1}{K} {\sum }_{k = 1}^{K} BCEWithLogits ( {z}_{aug , i , b , k} , {p}_{orig , b , k} ) . \qquad ( 6 )$$

The total weighted augmented loss is:

$${ℒ}_{BCE - W} = \frac{1}{NB} {\sum }_{i = 1}^{N} {\sum }_{b = 1}^{B} {w}_{i , b} {ℓ}_{i , b} . \qquad ( 7 )$$

The weights w_{i,b} in Eq. 7 dynamically modulate the contribution of each augmented sample based on its predictive divergence from the original sample, relative to other augmentations in the group. The dissimilarity between the i-th augmented prediction and the (detached) original prediction for sample b can be measured using the average BCE distance d_{i,b}:

$${d}_{i , b} = \frac{1}{K} {\sum }_{k = 1}^{K} {\sum }_{k = 1}^{K} BCEWithLogits ( {z}_{aug , i , b , k} , {p}_{orig , b , k} ) \qquad ( 9 )$$

where p_{orig,b}=σ(z_{orig,b})_{detached}.

For each sample b, the mean μ_{d,b} and standard deviation σ_{d,b} of these distances across the N augmentations can be computed:

$${μ}_{d , b} = \frac{1}{N} {\sum }_{i = 1}^{N} {d}_{i , b} \qquad ( 10 )$$

$${σ}_{d , b} = \sqrt{\frac{1}{N} {\sum }_{i = 1}^{N} {( {d}_{i , b} - {μ}_{d , b} )}^{2}} \qquad ( 11 )$$

The weight w_{i,b} is calculated using a Gaussian function centered at the mean distance μ_{d,b}, based on the z-score of the distance d_{i,b}:

$${z}_{i , b} = \frac{{d}_{i , b} - {μ}_{d , b}}{{σ}_{d , b} + ε} ; \qquad ( 12 )$$

$${w}_{i , b} = exp ( - \frac{{z}_{i , b}^{2}}{2 {s}^{2}} ) \qquad ( 13 )$$

where s is a hyper-parameter controlling the sensitivity to deviations from the mean distance, and ε is a small constant (e.g., 10⁻⁶) for numerical stability. This strategy assigns higher weights to augmentations whose predictive divergence is close to the average divergence observed for that sample across all N augmentations.

In an embodiment, the Entropy Maximization Loss 417 ( [symbol] ₑₙₜ) can be defined as a loss term encouraging diversity and uncertainty in the predictions derived from augmented features. The negative average binary entropy of the predicted probabilities for augmented samples can be minimized:

$${ℒ}_{ent} = - \frac{1}{NBK} {\sum }_{i = 1}^{N} {\sum }_{b = 1}^{B} {\sum }_{k = 1}^{K} H ( σ ( {z}_{aug , i , b , k} ) ) \qquad ( 8 )$$

where H(p)=−[plog p+(1−p)log(1−p)] is the binary entropy function.

In block 623, the training objective can be minimized as a combination of loss functions with regularization terms derived from the augmented samples. In an embodiment, this combination of the loss functions with regularization terms promotes robustness and diversity. The total loss [symbol] ₜₒₜₐₗ is a weighted sum of four components: [symbol] ₜₒₜₐₗ= [symbol] _{BCE}+λ_{distill} [symbol] _{distill}+λ_{augh} [symbol] _{BCE-W}+λₑₙₜ [symbol] ₑₙₜ (9) where λ_{distill}, λ_{aug}, λₑₙₜ are scalar hyper-parameters. Let y∈{0,1}^{B×K} be the ground truth multi-label matrix for the batch.

In block 630, entity level features can be extracted from the video frames by performing regions of interest alignment on an augmented feature map. In an embodiment, regions of interest (ROI) alignment is used to extract entity level features from the video features from the augmented feature map. ROI alignment extracts small, fixed-size feature maps from arbitrary-sized regions of interest obtained from a larger feature map. The regions of interest can include context of an entity performing an action. The augmented feature map 325 can be generated based on attention masks generated from video frames.

In block 631, attention masks can be generated by processing video frames obtained by a vision encoder with frozen weights that utilizes the LoRA parameters.

In an embodiment, after learning the LoRA parameters 323, action detection with few-shot adaptation can be performed. Video frames 303 can be processed by the frozen vision encoder 321 with LoRA parameters 323 and attention mask 311 generated using an attention mask generator 307 which takes as input the entity bounding boxes 301 which includes bounding box coordinates of all the entities in the image/video 102 to output an video feature map.

In an embodiment, to generate the attention masks 311, the attention mask generator 307 can take as input the top left and top right coordinates of the entity bounding boxes 301 and output the attention mask 311 as a zero-padded mask where the frame patch within the bounding box contains ones and outside is padded with zeros. The vision encoder 321 applies the attention mask 311 during attention computation to emphasize the features around the location of the entity in the frame and guide the LoRA parameters 323 to focus on the entity level details as an attention feature map. This attention feature map contains features per patch across all the input frames.

In block 633, top-k patches of features from an attention feature map can be selected based on their importance.

In an embodiment, a patch scoring module is utilized after processing half of the layers of the vision encoder 321 to score the patches based on their importance. To score the patches based on importance, the patch scoring module 503 takes the features of the patch features from previous layers and uses a linear layer plus a sigmoid function to output a score per patch. The sigmoid function outputs a score between 0 and 1 for each of the patches. Since the scoring function is learnable and conditioned on the patch features, it is directly optimized by the downstream task training. The scoring module will learn to score important patches (like human and objects the human interacts with) higher and background patches lower as they do not help with the action prediction.

In an embodiment, the patch scoring module 503 is implemented using a simple linear layer without the bias term. The patch scores can be used by the patch selection module 505 to select top-k patches where “k” is a heuristic parameter to control the tradeoff between computation and accuracy.

To control the tradeoff, the K value in top-K selection is set appropriately. For computation, the memory usage as well as latency of the model (how long it takes to process 1 clip using the model forward pass) can be considered. For accuracy, mean average precision can be utilized which checks how often the model can predict the correct actions while also considering the bounding box prediction of the entity detection.

In an embodiment, the patch selection module 505 can be any differentiable formulation of top-k operation such as straight through estimator or gumbel softmax approximation which selects the index of the top k maximum values from the patch scores generated by a patch scoring module 503 in a continuous manner. Only the selected patches are further processed by the corresponding layers (e.g., output layers). The output video feature map is padded with zeros for the ignored patches. The top-k patches can be processed by the output layers of the vision encoder 321 to generate the augmented feature maps 325.

For example, if the total patches in a video clip are 5000, using the scores from the scoring module select top-K patches are selected (e.g., K can be smaller compared to total patches like 32, 64 or 128). This way most of the layers in the model would not need to process all the 5000 patches and only the selected top-K. This drastically reduces the computation cost but also affects the accuracy as the model only sees few patches to decide on a specific action prediction. Depending on the types of actions, the larger the value of K the better the accuracy but that also means more compute resources can be spent. Because the action detection task can also be affected by background noise, only selecting a few important patches may also help with accuracy compared to processing all the patches as it will help reduce the background noise in the frames.

In block 640, an alignment loss can be minimized to maximize the similarity between action text embeddings and the ROI aligned embeddings and obtain an optimized ML model for performing downstream tasks.

In an embodiment, during training, the cosine similarity can be computed and force the model to minimize cross entropy loss using the cosine similarity output as the predicted logits with the ground truth labels. In another embodiment, other similarity methods can be employed such as Euclidean distance, dot product, etc. The cross entropy loss indirectly forces the model to maximize the cosine similarity between the ROI aligned embeddings vectors and the ground truth text embedding vectors.

During inference, a threshold can be utilized (e.g., a value between 0 and 1 such as 0.7 or 0.8 based on heuristics) to check whether the ROI aligned embeddings matches with the action text embeddings.

In block 641, the action labels are encoded by the frozen text encoder to produce action text embeddings.

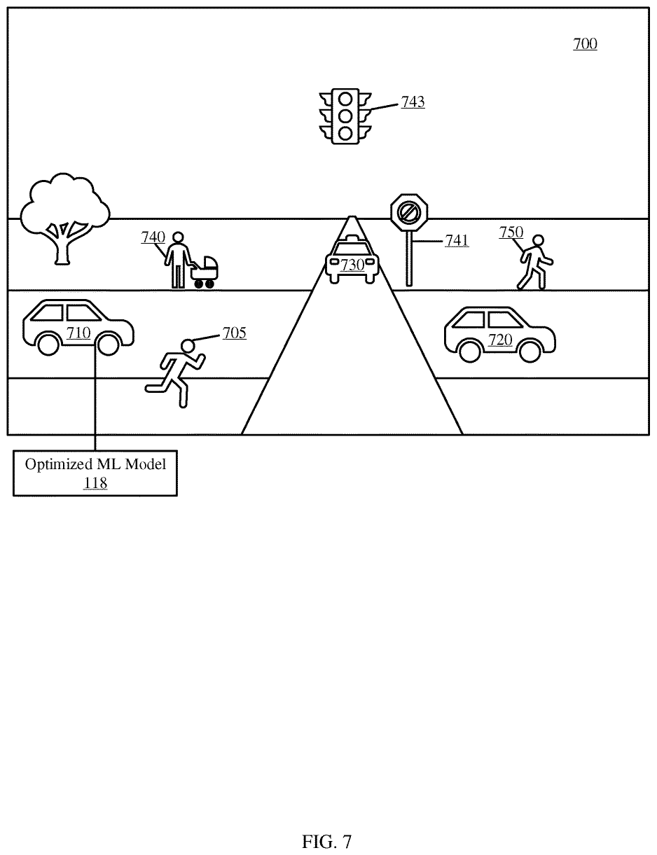

In an embodiment, the alignment loss can be a cosine similarity between the text and entity level embeddings. An example of the downstream tasks performed with the optimized ML model is shown in FIG. 7.

Referring now to FIG. 7, a block diagram showing a practical application for enhanced decision making through few-shot adaptation of artificial intelligence models for action detection, in accordance with an embodiment of the present invention.

In an embodiment, an autonomous vehicle 710 utilizes the optimized ML model 118. The autonomous vehicle 710 can detect entities and entity actions within traffic scene 700 including: entity 705 running on the sidewalk, entity 740 walking with a stroller on the sidewalk on the left side of autonomous vehicle 710, entity 750 walking on the same side as entity 740, entity 730 stopped at the intersection due to the traffic light 743 being red in the direction of entity 730 and green in the direction of autonomous vehicle 710, entity 720 turning right, and traffic sign 741 showing a no entry sign. These detections assist the autonomous decision making ability of the autonomous vehicle 710.

Based on the entity and action detections, autonomous vehicle 710 can generate a trajectory to control its movement through traffic scene 700 and avoid undesirable outcomes such as collisions through autonomous decision making. For example, autonomous vehicle 710 can go straight because its path is cleared after entity 720 turned right and changed lanes.

In another embodiment, the autonomous vehicle 710 can generate optimized trajectories through a traffic scene based on preference such as shorter distance, gas/range saving routes, comfort, etc. In another embodiment, the autonomous vehicle 710 can generate a notification for a decision-making entity (e.g., driver, passenger, owner, etc.) when the detected action (e.g., other entity movement, etc.) satisfies a predetermined trigger condition (e.g., predicted collision, predicted heavy traffic, etc.), wherein the notification supports the decision making entity's situational judgment and decision making (e.g., recommendation to reroute the vehicle, etc.).

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
obtaining augmented feature maps by injecting feature augmentations of detected features from video frames into a feature space of a vision encoder of a machine learning model;
training the vision encoder to learn low rank adaptation parameters based on the augmented feature maps;
extracting entity level features from the video frames by performing region of interest alignment on the augmented feature maps obtained by the vision encoder injected with low rank adaptation (LoRA) parameters; and
maximizing similarity between the entity level features and action text embeddings obtained from the video frames by minimizing an alignment loss to train the machine learning model and obtain an optimized machine learning model for performing downstream tasks.

2. The method of claim 1, wherein obtaining the augmented feature maps further comprises generating feature augmentations based on modulating parameters predicted by a parameter generator based on a learnable embedding table of the detected features.

3. The method of claim 1, wherein obtaining the augmented feature maps further comprises modulating the detected features from the video frames by performing feature-wise linear modulation.

4. The method of claim 1, wherein training the vision encoder further comprises minimizing a training objective as a combination of loss functions with regularization terms derived from augmented samples.

5. The method of claim 4, wherein the loss functions include computing a weighted augmented loss that reflects reasonableness of an augmentation per sample.

6. The method of claim 1, wherein extracting the entity level features further comprises generating attention masks by processing video frames obtained by the vision encoder with frozen weights.

7. The method of claim 1, further comprising generating a notification for a decision-making entity when the detected action satisfies a predetermined trigger condition, wherein the notification supports situational judgment and decision making of the decision-making entity.

8. The method of claim 1, further comprising generating a trajectory to control an autonomous vehicle to avoid collisions responsive to detected entities and their corresponding detected actions within a traffic scene.

9. A system, comprising:
a memory device;
one or more processor devices operatively coupled with the memory device to perform operations including:
obtaining augmented feature maps by injecting feature augmentations of detected features from video frames into a feature space of a vision encoder of a machine learning model;
training the vision encoder to learn low rank adaptation parameters based on the augmented feature maps;
extracting entity level features from the video frames by performing region of interest alignment on the augmented feature maps obtained by the vision encoder injected with low rank adaptation (LoRA) parameters; and
maximizing similarity between the entity level features and action text embeddings obtained from the video frames by minimizing an alignment loss to train the machine learning model and obtain an optimized machine learning model for performing downstream tasks.

10. The system of claim 9, wherein obtaining the augmented feature maps further comprises generating feature augmentations based on modulating parameters predicted by a parameter generator based on a learnable embedding table of the detected features.

11. The system of claim 9, wherein obtaining the augmented feature maps further comprises modulating the detected features from the video frames by performing feature-wise linear modulation.

12. The system of claim 9, wherein training the vision encoder further comprises minimizing a training objective as a combination of loss functions with regularization terms derived from augmented samples.

13. The system of claim 12, wherein the loss functions include computing a weighted augmented loss that reflects reasonableness of an augmentation per sample.

14. The system of claim 9, wherein extracting the entity level features further comprises generating attention masks by processing video frames obtained by the vision encoder with frozen weights.

15. The system of claim 9, further comprising generating a notification for a decision-making entity when the detected action satisfies a predetermined trigger condition, wherein the notification supports situational judgment and decision making of the decision-making entity.

16. The system of claim 9, further comprising generating a trajectory to control an autonomous vehicle to avoid collisions responsive to detected entities and their corresponding detected actions within a traffic scene.

17. A non-transitory computer program product comprising a computer-readable storage medium including a program code, wherein the program code when executed on a computer causes the computer to perform operations including:
obtaining augmented feature maps by injecting feature augmentations of detected features from video frames into a feature space of a vision encoder of a machine learning model;
training the vision encoder to learn low rank adaptation parameters based on the augmented feature maps;
extracting entity level features from the video frames by performing region of interest alignment on the augmented feature maps obtained by the vision encoder injected with low rank adaptation (LoRA) parameters; and
maximizing similarity between the entity level features and action text embeddings obtained from the video frames by minimizing an alignment loss to train the machine learning model and obtain an optimized machine learning model for performing downstream tasks.

18. The non-transitory computer program product of claim 17, wherein obtaining the augmented feature maps further comprises generating feature augmentations based on modulating parameters predicted by a parameter generator based on a learnable embedding table of the detected features by performing feature-wise linear modulation.

19. The non-transitory computer program product of claim 17, wherein training the vision encoder further comprises minimizing a training objective as a combination of loss functions, including a weighted augmented loss that reflects reasonableness of an augmentation per sample with regularization terms derived from the augmented samples.

20. The non-transitory computer program product of claim 17, further comprising generating a notification for a decision-making entity when the detected action satisfies a predetermined trigger condition, wherein the notification supports situational judgment and decision making of the decision-making entity.
